(19) United States
(12) Patent Application Publication
(10) Pub. No.: US 2009/0234991 A1
(43) Pub. Date: Sep. 17, 2009

(54) ENHANCED THROUGHPUT COMMUNICATION WITH A PERIPHERAL DEVICE

(75) Inventors: Shreyas Abhay Kale, Morrisville, NC (US); Julie Morris, Raleigh, NC (US); Justin Monroe Pierce, Cary, NC (US); Richard W. Vanderpool, III, Raleigh, NC (US)

Correspondence Address: IBM CORPORATION (SS/NC);c/o STREETS & STEELE, 13831 NORTHWEST FREEWAY, SUITE 355, HOUSTON, TX, 77040, US

(73) Assignee: INTERNATIONAL BUSINESS MACHINES CORPORATION, Armonk, NY (US)

(21) Appl. No.: 12/049,440

(22) Filed: Mar. 17, 2008

(51) Int. Cl. G06F 13/12

(52) U.S. Cl. 710/72

(57) ABSTRACT

Method, computer program product and system for communicating data between an operating system and a single peripheral device over a bus having a plurality of hubs. Portions of the data are sequentially directed through the plurality of hubs. Preferably, the portions of the data are substantially equally sized blocks of the data. Effective data transfer rates can be increased by connecting the peripheral to two root hubs instead of just one. The data storage system comprises a host computer including an operating system and a bus having a plurality of hubs, a single peripheral device coupled to the hubs, and a processor for communication with the peripheral device.

### BACKGROUND OF THE INVENTION

1. Field of the Invention

The present invention relates to communication over a peripheral bus to a peripheral device, such as a flash memory device.

2. Description of the Related Art

A universal serial bus (USB) is a serial bus standard to interface devices. USB was designed to allow peripherals to be connected using a single standardized interface socket and to improve plug-and-play capabilities by allowing devices to be connected and disconnected without rebooting the computer. Other convenient features include providing power to low-consumption devices without the need for an external power supply and allowing many devices to be used without requiring manufacturer specific, individual device drivers to be installed. USB is intended to help retire all legacy varieties of serial and parallel ports. USB can connect computer peripherals such as mouse devices, keyboards, PDAs, gamepads and joysticks, scanners, digital cameras, printers, personal media players, and flash drives. For many of those devices USB has become the standard connection method.

A USB system has an asymmetric design, consisting of a host, a multitude of downstream USB ports, and multiple peripheral devices connected in a tiered-star topology. USB devices are linked in series through hubs. There always exists one hub known as the root hub, which is built-in to the host controller. Additional USB hubs may be included in the tiers, allowing branching into a tree structure. A USB host may have multiple host controllers and each host controller may provide one or more USB ports.

A single physical USB device may consist of several logical sub-devices that are referred to as device functions, because each individual device may provide several functions, such as a webcam (video device function) with a built-in microphone (audio device function). USB endpoints actually reside on the connected device and the logical channels for communication with the host are referred to as pipes. Pipes are connections from the host controller to a logical entity on the device named an endpoint. Each endpoint can transfer data in one direction only, either into or out of the device, so each pipe is uni-directional. Endpoints are grouped into interfaces and each interface is associated with a single device function. An exception to this is endpoint zero, which is used for device configuration and which is not associated with any interface.

When a new USB device is connected to a USB host, the USB device enumeration process is started. The enumeration process first sends a reset signal to the USB device. The speed of the USB device is determined during the reset signaling. After reset, USB device setup information is read from the device by the host and the device is assigned a unique host-controller specific 7-bit address. If the device is supported by the host, the device drivers needed for communicating with the device are loaded and the device is set to a configured state. If the USB host is restarted, the enumeration process is repeated for all connected devices.

The host controller polls the bus for traffic, usually in a round-robin fashion, so that no USB device can transfer any data on the bus without an explicit request from the host controller. Devices that attach to the bus can be specialized devices requiring a device-specific device driver to be used, or may belong to a device class. These device classes define an expected behavior in terms of device and interface descriptors so that the same device driver may be used for any device that claims to be a member of a certain class. An operating system is supposed to implement all device classes so as to provide generic drivers for many USB devices.

USB standards generally support three data rates. A Low Speed rate of 1.5 Mbit/s (187 kB/s) is mostly used for Human Interface Devices (HID) such as keyboards, mice, and joysticks (available under USB Specifications 1.1 and 2.0). A Full Speed rate of 12 Mbit/s (1.5 MB/s) (available under USB Specifications 1.1 and 2.0) divides its USB bandwidth between USB devices in a first-come first-served basis. A Hi-Speed rate of 480 Mbit/s (60 MB/s) is currently the fastest speed in use (available only under USB Specification 2.0).

### BRIEF SUMMARY OF THE INVENTION

One embodiment of the invention provides a method comprising communicating data between an operating system and a single peripheral device over a bus having a plurality of hubs, and sequentially directing portions of the data through the plurality of hubs. Preferably, the portions of the data are substantially equally sized blocks of data. The plurality of hubs may be root hubs to increase the speed at which the data is communicated. Optionally, the data portions may be sequentially directed to the hubs in a round-robin manner, sending one data portion to each of the plurality of hubs before repeating. The bus may be any peripheral bus technology in which multiple connections to a system can increase throughput, such as, without limitation, a universal serial bus, FireWire, Ethernet, RS-232, RS-485, Fibre Channel, PCI Express, Serial Attached SCSI, and Serial ATA.

Another embodiment of the invention provides a computer program product including computer readable instructions embodied on a computer readable medium. The computer readable instructions comprise instructions for communicating data between an operating system and a single peripheral device over a bus having a plurality of hubs, and instructions for sequentially directing portions of the data through the plurality of hubs.

A further embodiment of the invention provides a data storage system. The data storage system comprises a host computer including an operating system and a bus having a plurality of hubs, a single peripheral device coupled to the plurality of hubs, and a processor in the host computer for communication with the peripheral device, wherein the processor executes instructions embodied on a computer readable medium. The instructions comprise instructions for communicating data between the operating system and the single peripheral device over the bus, and instructions for sequentially directing portions of the data through the plurality of hubs.

Other embodiments, aspects, and advantages of the invention will be apparent from the following description and the appended claims.

### BRIEF DESCRIPTION OF THE DRAWINGS

FIG. 1 is a block diagram of a host device.

FIG. 2 is a block diagram of a USB implementation between a host and a physical peripheral device.

FIG. 3 is a simplified block diagram of a USB flash memory device coupled to two USB hubs.

### DETAILED DESCRIPTION OF THE INVENTION

One embodiment of the invention provides a method comprising communicating data between an operating system and a single peripheral device over a bus having a plurality of hubs, and sequentially directing portions of the data through the plurality of hubs. Preferably, the portions of the data are substantially equally sized blocks of data. The data may be communicated from the operating system to the peripheral device, or from the peripheral device to the operating system. To accommodate these communications, the single peripheral device is coupled to a plurality of physical ports for communication with an equal plurality of hubs.

The peripheral device may be any available type of peripheral device that would benefit from additional throughput of data, such as a data storage device, network device, multimedia or video device, and the like. In embodiments where the peripheral is a memory device that stores the data, such as where the peripheral device is a flash drive, the data may later be read from the memory device and communicated from the memory device to the operating system. Specifically, the data may be communicated from the memory device to the operating system by sequentially directing portions of the data through the plurality of hubs.

A single physical memory drive may be plugged into a computer system using one USB connection or, with the use of a device-specific device driver, using two USB connections. A device-specific device driver is provided for sending and receiving data with one USB device plugged into two USB hubs using block-level striping for the purpose of increasing the speed by which data can be sent and received. The device-specific device driver causes the two USB hubs to sequentially send or receive data block-by-block to the same USB device.

The device-specific device driver is a computer program allowing the operating system or other higher-level computer program or application to communicate with a specific USB device. When a calling program invokes a routine in the driver, the driver issues one or more commands to the device. Once the device provides identifying information to the device-specific device driver, the driver may invoke routines in the original calling program. The device-specific driver is hardware-dependent and specific to the operating system. The driver accepts generic instructions from the calling program and converts them into low-level commands required by the device. Optionally, the device-specific driver will provide the interrupt handling required for any necessary asynchronous time-dependent hardware interface.

The device-specific driver is preferably a loadable device driver that is loaded in response to detecting that the single USB device has been coupled to one or more USB hubs. For example, the device enumeration process provides the host with information about each coupled device. If two hubs simultaneously receive a device of the same type or identification, then the device-specific driver may enter a special mode for controlling the operation of the both hubs with data striping according to previously described embodiments of the invention. Most preferably, the device-specific driver will transition between a mode of operating a single device on a single hub and another mode of operating one or more devices over a plurality of hubs.

In accordance with a further embodiment of the invention, the device-specific device driver presents the USB device to the operating system as a single logical device, yet sends commands and data to the USB device through independent instances of the host controller and hub. Optionally, the device driver may be abstracted into logical and physical layers. For example, the logical layer may process the operating system instructions and divide the data into stripes for sending to independent host controllers. The physical layer may then generate appropriate low-level commands that are device-specific and sequentially transfer data blocks to different instances of the host controller and hub. Conversely, when the hardware device needs to respond to the operating system, it uses the physical layer of the driver to speak through the logical layer of the driver.

A typical USB root hub follows a USB communication protocol that limits the rate of data transfer. For example, the current USB 2.0 protocol limits data transfer to 480 Mbps. When the USB device is coupled to two independent root hubs operating at this speed, one embodiment of the invention approaches an effective speed of about 960 Mbps. For example, a device-specific device driver for a USB flash drive will accept a request from the operating system to write data to the USB flash drive. The device-specific device driver divides the data stream into stripes of data blocks, and sequentially sends each block to one of the USB root hubs that are in communication with the USB device. The operating system and/or the device-specific device driver buffers data for the hubs in order to keep them each busy until the data transfer is completed. Accordingly, the data transfer rate to a USB device, such as a flash drive, is increased by transferring data through two USB root hubs.

In another embodiment, a single USB device has two plugs for coupling with two USB hubs, but is capable of plugging into only one USB hub for normal speed operation (i.e., low speed, full speed or hi-speed according to USB 2.0 communication protocols). When plugged into only one USB hub, the USB device may be operated using either a standard class driver or the device-specific device driver.

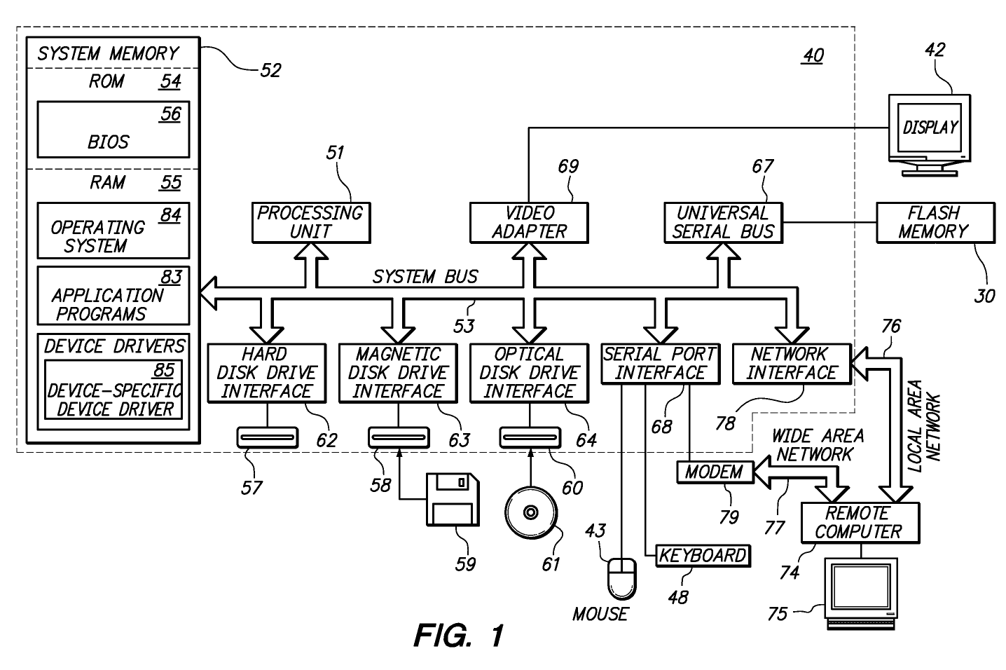

FIG. 1 is a schematic diagram of the computer system 40 in communication with a flash memory device 30 over a universal serial bus 67. The system 40 is shown as a general-purpose computing device in the form of a conventional personal computer, but the system may be in the form of a server or other system having a universal serial bus. Generally, the computer 40 includes a processing unit 51, a system memory 52, and a system bus 53 that couples various system components including the system memory 52 to processing unit 51. System bus 53 may be any of several types of bus structures including a memory bus or memory controller, a peripheral bus, and a local bus using any of a variety of bus architectures. The system memory can include a read-only memory (ROM) 54 and random-access memory (RAM) 55. A basic input/output system (BIOS) 56, containing the basic routines that help to transfer information between elements within computer 40, such as during start-up, can be stored in ROM 54.

Computer 40 further includes a hard disk drive interface 62 for reading from and writing to a logical data storage device 10, a magnetic disk drive 58 for reading from or writing to a removable magnetic disk 59, and an optical disk drive 60 for reading from or writing to a removable optical disk 61 such as a CD-ROM or other optical media. Hard disk drive 57, magnetic disk drive 58, and optical disk drive 60 are connected to system bus 53 by a hard disk drive interface 62, a magnetic disk drive interface 63, and an optical disk drive interface 64, respectively. Although the exemplary environment described herein employs the logical data storage device 10, removable magnetic disk 59, and removable optical disk 61, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. These storage devices and their associated computer readable media provide nonvolatile storage of computer-executable instructions, data structures, program modules, and other data for the computer 40.

A user may enter commands and information into personal computer 40 through input devices, such as a keyboard 48 and a pointing device, such as a mouse 43. Other input devices (not shown) may include a microphone, joystick, game pad, satellite dish, scanner, or the like. These and other input devices are often connected to processing unit 51 through a serial port interface 68 that is coupled to the system bus 53, but input/output devices may be connected by other interfaces, such as a parallel port, game port, a universal serial bus (USB) 67, IEEE 1394 (Firewire), special adapter, wireless transmission, LAN attachment, an internet connection or the like. A display device 42 may also be connected to system bus 53 via an interface, such as a video adapter 69. In addition to the display device, personal computers typically include other peripheral output devices (not shown), such as speakers and printers.

The computer 40 may operate in a networked environment using logical connections to one or more remote computer 74. The remote computer 74 may be another personal computer, a server, a client, a router, a network PC, a peer device, a mainframe, a personal digital assistant, an Internet-connected mobile telephone, an Internet-connected camera, or other common network node. While a remote computer 74 typically includes many or all of the elements described above relative to the computer 40, only a display and keyboard 75 has been illustrated in the figure. The logical connections depicted in the figure include a local area network (LAN) 76 and a wide area network (WAN) 77. Such networking environments are commonplace in offices, enterprise-wide computer networks, intranets, and the Internet.

When used in a LAN networking environment, the computer 40 is often connected to the local area network 76 through a network interface or adapter 78. When used in a WAN networking environment, the computer 40 typically includes a modem 79 or other means for establishing high-speed communications over WAN 77, such as the Internet. A modem 79, which may be internal or external, is connected to system bus 53 via serial port interface 68. In a networked environment, program modules depicted relative to personal computer 40, or portions thereof, may be stored in the remote memory storage device 75. It will be appreciated that the network connections shown are exemplary and other means of establishing a communications link between the computers may be used. A number of program modules may be stored on one of the data storage devices, ROM 54, or RAM 55, including an operating system 84, an application program 83, and a device-specific device driver 85.

The devices shown in FIG. 1 should not imply that the invention has architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like.

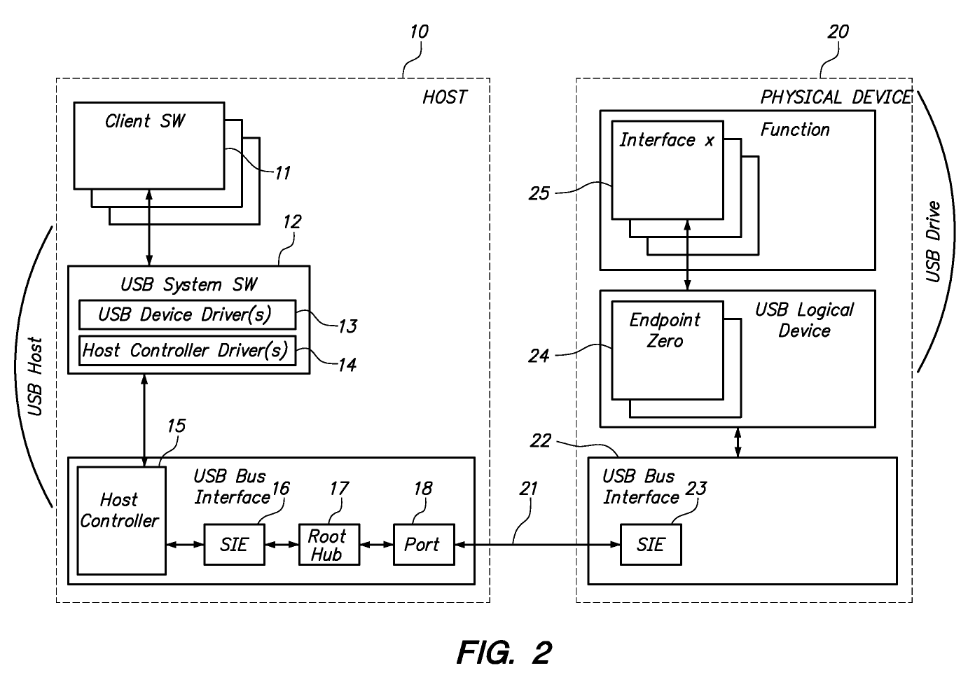

FIG. 2 is a block diagram of a USB implementation between a host 10 and a physical peripheral device 20. The host 10 operates client software 11, such as an operating system and various application programs, which communicates with USB system software 12. The USB system software 12 includes USB device drivers 13, including standard device class drivers and device-specific device drivers, and host controller drivers 14. The USB device driver 13 receives commands and data from the client software 11 (typically the operating system) and provides low-level device specific instructions to the host controller driver 14, which operates the host controller 15. The host controller 15 then communicates through a serial interface engine 16 to a root hub 17, which physically terminates in a port 18.

The physical device 20 is coupled to the USB host 10 via a USB wire or plug 21. A USB bus interface 22 has its own serial interface engine 23 and passes information to/from a desired endpoint 24. An endpoint 24 further communicates with an interface 25 of the desired function of the physical device 20. For example, where the physical device 20 is a flash drive, there may be a single function (memory) having a single interface 25 with dual endpoints 24 (read and write). In accordance with various embodiments of the present invention, a device-specific USB device driver 13 may communicate with two instances of the host controller driver 14 to effect operation of two host controllers 15 and two root hubs 17.

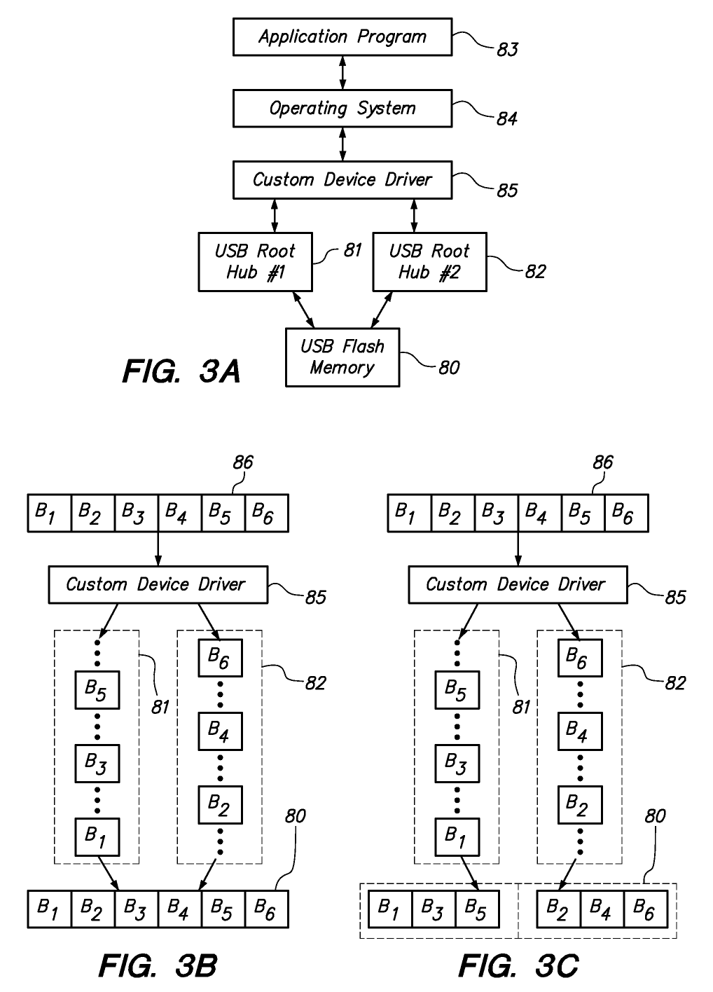

FIG. 3A is a simplified block diagram of a USB flash memory device 80 coupled to two USB root hubs 81, 82. An application program 83 utilizes the operating system 84 to send commands and data to the USB flash memory 80. The operating system 84 loads the device-specific device driver 83 upon detecting that the enumerated USB flash memory 80 has been coupled to a first USB root hub 81 and a second USB root hub 82. Accordingly, the device-specific device driver 83 divides data into alternating portions or blocks for sending through the two root hubs 81, 82. Although FIGS. 3A-C are described with respect to a USB flash memory 80, it should be recognized that the method described herein may be equally applicable to other types of physical peripheral devices. The method is particularly beneficial for use with peripheral devices that require a high rate of data communication.

FIG. 3B is a schematic diagram illustrating how data is divided and sent through two root hubs. Data 86 is shown schematically as including a sequence of six data blocks B₁-B₆ in order. The device-specific device driver 85 divides the data and transfers alternating blocks of data through the two root hubs 81, 82. Specifically, the device-specific device driver sends each of the blocks, one-by-one, to the flash memory 80 by first sending block B₁ to the first root hub 81, then sending block B₂ to the second root hub 82, and continuing in an alternating pattern until all of the data has been sent. As a result, the odd numbered data blocks B₁, B₃, and B₅ are sent through the first root hub 81 and the even numbered data blocks B₂, B₄, and B₆ are sent through the second root hub 82. By sending the data blocks from the device-specific device driver 85 in a sequence, the data blocks are received by the USB flash drive 80 in sequence. Because the USB flash drive 80 is able to store and read information much faster than the 480 MBit/s rate limitation of each root hub 81, 82, the drive is able to keep up with the demands of both hubs. The result is a much higher effective rate of data transfer from the driver 85 to the flash drive 80.

While the diagram of FIG. 3B appears to store the data in a single physical device with no logical separation, FIG. 3C illustrates transfer of the data through two root hubs 81, 82 to either two physical devices or one physical device containing two logical devices. Each physical device preferably includes a controller that receives and handles the data. Optionally, the physical device may also include a communication control device that controls the processing of the physical layer of communication. Although this component is useful these functions may alternatively be performed by the controller.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
communicating data between an operating system and a single peripheral device over a bus having a plurality of ports; and
sequentially directing portions of the data through the plurality of ports.

2. The method of claim 1, wherein the alternating portions of the data are substantially equally sized blocks of the data.

3. The method of claim 1, wherein the data is communicated from the operating system to the peripheral device.

4. The method of claim 3, wherein the peripheral device is a mass storage device.

5. The method of claim 4, further comprising:
storing the data on the memory device; and then
reading the data from the memory device and communicating the data from the memory device to the operating system.

6. The method of claim 5, wherein the data is communicated from the memory device to the operating system by sequentially directing portions of the data through the plurality of ports.

7. The method of claim 1, wherein the single peripheral device is coupled to a plurality of physical ports for communication with an equal plurality of hubs.

8. The method of claim 1, further comprising:
exposing the single peripheral device as a single logical device to the operating system.

9. The method of claim 4, further comprising:
storing the data on the memory device.

10. The method of claim 1, wherein the plurality of ports are coupled to separate root hubs, and wherein the effective data transfer rate between the operating system and the single peripheral device is greater than when the plurality of ports are not coupled to separate root hubs.

11. The method of claim 1, wherein the bus is a universal serial bus.

12. The method of claim 1, wherein the step of sequentially directing portions of the data through the plurality of ports is automatically performed in response to the single peripheral device being coupled to the plurality of ports; and further comprising:
automatically directing data through only one of the ports in response to the single peripheral device being coupled to only one of the ports.

13. A computer program product including computer readable instructions embodied on a computer readable medium, the computer readable instructions comprising:
instructions for communicating data between an operating system and a single peripheral device over a bus having a plurality of ports; and
instructions for sequentially directing portions of the data through the plurality of ports.

14. The computer program product of claim 13, wherein the portions of the data are substantially equally sized blocks of the data.

15. The computer program product of claim 13, wherein the peripheral device is a memory device.

16. A data storage system, comprising:
a host computer including an operating system and a bus having a plurality of ports;
a single peripheral device coupled to the plurality of ports; and
a processor in the host computer for communication with the peripheral device, wherein the processor executes instructions embodied on a computer readable medium, the instructions comprising:
instructions for communicating data between the operating system and the single peripheral device over the bus; and
instructions for sequentially directing portions of the data through the plurality of ports.

17. The data storage system of claim 16, wherein the portions of the data are substantially equally sized blocks of the data.

18. The data storage system of claim 17, wherein the peripheral device is a memory device.

19. The data storage system of claim 16, wherein the plurality of ports are coupled to separate root hubs, and wherein the effective data transfer rate between the operating system and the single peripheral device is greater than when the plurality of ports are not coupled to separate root hubs.

20. The data storage system of claim 16, wherein the bus is a universal serial bus.
